(19) United States
(12) Patent Application Publication
(10) Pub. No.: US 2026/0330190 A1
(43) Pub. Date: Oct. 22, 2026

(54) ACCELERATOR FOR ACCELERATING INFERENCE PROCESS OF UNSTRUCTURED SPARSE LARGE LANGUAGE MODEL AND OPERATION METHOD THEREFOR

(71) Applicant: EASTERN INSTITUTE OF TECHNOLOGY,NINGBO, Ningbo (CN)

(72) Inventors: Chen WU, Ningbo (CN); Jinming LYU, Ningbo (CN); Shaoqiang LU, Ningbo (CN); Tiandong ZHAO, Ningbo (CN); Siyuan MIAO, Ningbo (CN)

(73) Assignee: EASTERN INSTITUTE OF TECHNOLOGY,NINGBO, Ningbo (CN)

(21) Appl. No.: 19/653,103

(22) Filed: Apr. 21, 2026

Related U.S. Application Data
(63) Continuation of application No. PCT/CN2025/129976, filed on Oct. 24, 2025.

(30) Foreign Application Priority Data
Oct. 25, 2024 (CN) 2024115037962

(51) Int. Cl. G06N 3/0455; G06F 17/16

(52) U.S. Cl. CPC G06N 3/0455; G06F 17/16

(57) ABSTRACT

Disclosed are an accelerator for accelerating an inference process of an unstructured sparse large language model and an operation method therefor. The accelerator includes a processor module, a direct memory access module, a memory controller module, a double-data-rate (DDR) memory module, an interconnect bus module, a computing core module, and a router module. The interconnect bus module is connected to the direct memory access module, the memory controller module, and the computing core module. The processor module is connected to the direct memory access module. The DDR memory module is connected to the memory controller module. The router module is connected to the computing core module and an adjacent router module. The computing core module acquires data to be computed from an off-chip DDR memory module via the interconnect bus module.

### CROSS-REFERENCE TO RELATED APPLICATIONS

The application claims priority to Chinese patent application No. 2024115037962, filed on Oct. 25, 2024, the entire contents of which are incorporated herein by reference.

### TECHNICAL FIELD

This disclosure relates to the field of information technology, and specifically relates to an accelerator for accelerating an inference process of an unstructured sparse large language model and an operation method therefor.

### BACKGROUND

With the development of deep learning, a large language model achieves remarkable success in many applications. For instance, in popular applications including chatbots, the large language model can engage in interactive dialogues with human users. During a conversation, the large language model first comprehends the question from users with context (referred to as a prefill stage) and then generates responses token by token (known as a decode stage). However, the powerful function of the large language model is from enormous number of parameters and computations. For example, ChatGPT based on the GPT4 model, developed by OpenAI, as one of the most popular chatbots, has 1.8 trillion weight parameters. Generating a single token requires at least 540 TFLOP of computing power, which poses a great challenge to the limited storage, memory bandwidth, and computational capabilities of hardware devices.

Parameter sparsification in the large language model is an effective method to further accelerate the large language model by reducing computational complexity and memory usage rate. In some algorithmic research works, other structured sparsity of different granularities is provided. However, if evaluating the performance of large language models with different sparsity patterns on the WikiText 2 dataset, it is found that the unstructured sparsity achieves a 7.22 perplexity and a 60% parameter reduction by focusing on two metrics, namely, parameter reduction (the higher, the better) and perplexity (the lower, the better). This observation result indicates that the unstructured sparsity outperforms structured sparsity in terms of parameter reduction while maintaining model performance. Nevertheless, it is a challenge to fully utilize the significant parameter reduction brought by the unstructured sparsity, because it is difficult to utilize data reuse from its irregular sparsity patterns.

The inference process of the large language model consists solely of a decoder module of the Transformer. First, query (Q), key (K), and value (V) tensors are generated by a shape of LXD (a hidden dimension size) through three linear operations. Then, multi-head attention (MHA) computations are performed, and layer normalization is applied to the hidden dimension. Finally, a feed-forward network (FFN) expands the hidden dimension size to 4 times of D and then shrinks same back to the dimension of D. The large language model stacks many decoder layers, and text generation is divided into a prefill stage and a plurality of consecutive generation stages. In the prefill stage, a first output token is outputted from the context in the order of the decoder layers. Then, in the generation stage, at each step, an output token from a previous step is used as an input to generate a next token. This process continues until certain conditions are met, such as generating an end-of-sequence (EOS) token. The differences between the two stages lie in that on the one hand, in the generation stage, a hidden state input is a 1×D vector, which is different from the prefill stage that is prone to computational limitations and constrained by matrix-matrix multiplications with a large L, and the generation stage tends to be memory-limited and constrained by vector-matrix multiplications; and on the other hand, the generation stage performs cross-attention, which concatenates K and V tensors generated in the current decoding step with the tensors from the prefill stage and previous generation steps. The reuse of on-chip KV cache ensures the autoregressive property and avoids recomputation. However, it can be seen that the usage cycle of the KV cache is long, lasting until the end of the conversation, which poses challenges to memory management.

Existing work has poor support for unstructured sparse large language models. Google proposed Flex TPU for unstructured sparse computation, which involves arranging non-zero values in a row-continuous manner on a systolic array and storing same continuously from a top-left processing element (PE) to a bottom-right PE, to form a Z pattern known as Z mapping. Although this approach can reduce the number of iterations, it only focuses on fully utilizing the PE in space while requiring more waiting time in the temporal dimension. For example, a certain row in an array may come from three different rows of an original unstructured sparse matrix, which causes input feed time to be extended by three times. In addition, during the mapping process, a separator needs to be inserted between different rows as an interval, which also leads to idle PE and fails to fully fill the non-zero values. To implement these operations, the design within each PE becomes complex, incorporating a four-state state machine for control, which introduces overhead in data path selection.

### SUMMARY

### Technical Problem

In the prior art, an unstructured sparse large language model, due to the enormous number of parameters and high computational requirements, highly demands on the storage, memory bandwidth, and computational capabilities of hardware devices. Moreover, the irregular sparsity patterns make data reuse challenging, and the current hardware and algorithms offer poor support for the unstructured sparse large language model, leading to problems of inefficient memory management and low computational efficiency.

### Technical Solution

In response to the problems that an unstructured sparse large language model in the prior art, due to the enormous number of parameters and high computational requirements, highly demands on the storage, memory bandwidth, and computational capabilities of hardware devices, and moreover, the irregular sparsity patterns make data reuse challenging, and the current hardware and algorithms offer poor support for the unstructured sparse large language model, leading to inefficient memory management and low computational efficiency, this disclosure provides an accelerator for accelerating an inference process of an unstructured sparse large language model, which breaks the limitations of traditional systolic arrays, where data reuse is confined to a single row or column only, enabling cross-row and cross-column data reuse, and alleviating the pressure on hardware devices. Moreover, bitmasks are used to encode positions of non-zero elements, to enhance computational efficiency.

To achieve the above objective, this disclosure provides the following technical solutions.

In a first aspect, this disclosure provides an accelerator for accelerating an inference process of an unstructured sparse large language model, including: a processor module, a direct memory access module, a memory controller module, a double-data-rate (DDR) memory module, an interconnect bus module, a computing core module, and a router module, where
the interconnect bus module is connected to the direct memory access module, the memory controller module, and the computing core module; the processor module is connected to
the direct memory access module; the DDR memory module is connected to the memory controller module; and the router module is connected to the computing core module and an adjacent router module;
the computing core module acquires data to be computed from an off-chip DDR memory module via the interconnect bus module;
a processor runs a compiler to generate instructions and weight parameters for a large language model, and sends the instructions and the weight parameters to the DDR memory module via the direct memory access module; and then the computing core module acquires the instructions and executes same one by one;

the computing core module transfers data with each other via the router module to achieve multi-core computation of a non-linear function; and the computing core module acquires the data to be computed from the DDR memory module via the interconnect bus module; and
the memory controller module processes memory read and write requests from the interconnect bus module and sends the memory read and write requests to the DDR memory module.

In a further improvement of this disclosure, the computing core module includes: an instruction control unit module, a bitmask decoder module, a diagonal dataflow systolic array module, a post-processing module, an instruction cache module, a mask cache module, a weight cache module, a feature cache module, a result cache module, a hyperparameter cache module, and a KV cache module;
the processor module runs a software compiler to generate instructions for a sparse large language model and sends the instructions to the DDR memory module via the direct memory access module; the instruction control unit module acquires the instructions from the instruction cache module and prepares for execution; the computing core module acquires data from the weight cache module and the feature cache module and feeds the data into the diagonal dataflow systolic array module for dense or sparse matrix computation; computation results are saved to the result cache module and are processed by the post-processing module; and processed results are then saved to the DDR memory module for a next round of computation or for use by other system components;
the instruction control unit module is configured to control a behavior of each module within the computing core module during operation;
the bitmask decoder module is configured to decode a bitmask matrix of an unstructured sparse large language model, translate position information before sparsification, to obtain a position of the position information before sparsification in an original matrix, and feed translation results to the diagonal dataflow systolic array module;
the diagonal dataflow systolic array module is configured to perform sparse-dense matrix multiplication and dense-dense matrix multiplication operations for the unstructured sparse large language model;
the post-processing module is configured to perform non-linear operations and special data conversion processes in the large language model;
the instruction cache module is configured to cache instructions during a model inference process for acquiring by the instruction control unit module;
the mask cache module is configured to cache a bitmask matrix of the unstructured sparse large language model before compression for acquiring by the bitmask decoder module, and read data from the DDR memory module for updating in each round of computation;
the weight cache module is configured to cache weight parameters of the unstructured sparse large language model after compression, serving as a left-hand matrix to be multiplied in the diagonal dataflow systolic array module;
the feature cache module is configured to cache feature map data inputted by users of the large language model, and the feature map data is fed into a right-hand matrix to be multiplied in the diagonal dataflow systolic array module;
the KV cache module is configured to cache K and V matrices during a generation phase in an inference process of the large language model, and the K and V matrices are used when generating a next word; and
the result cache module is configured to cache partial sum (PSUM) results after the multiplication in a diagonal dataflow systolic array and perform cyclic accumulation for multiple rounds of matrix multiplications, and after completion, the results are saved to the off-chip DDR memory module or an on-chip KV cache module.

In a further improvement of this disclosure, the diagonal dataflow systolic array module includes an input feeding module, a non-zero loader module, a PE module, a crossbar switch module, a result merging module, and a result accumulation module, where
the input feeding module is connected to a first-stage crossbar switch module; the non-zero loader module is connected from a top to data lines of each column of the PE module; each stage of the crossbar switch is connected to PE modules on a diagonal where the crossbar switch is located, and is connected to crossbar switch modules of adjacent preceding and following stages; each PE module is connected to crossbar switches on a diagonal and is connected to upper and lower adjacent PE modules in a same column; and the result merging module is connected to PE modules in a last row and is connected to the result accumulation module.

In a further improvement of this disclosure, in the input feeding module, data is acquired and arranged in a streamlined organization into a staggered form required by an array; the non-zero loader module cooperates with the bitmask decoder module to feed matched weights and masks into the array together; where input feature data is inputted from a top-left corner and is fed downwards each time; the weights flow in from the top and are pinned and stored within the PE module; the PE module obtains the required feature data from the crossbar switch module according to ID numbers of the weights, performs multiply-accumulate operations, and decides whether to accumulate an output result of a previous PE module; and a column result of each PE module is outputted downwards to the result merging module, cross-column accumulation is performed in the result accumulation module, and then PSUM is accumulated over multiple rounds to obtain a final result.

In a further improvement of this disclosure, the diagonal dataflow systolic array module employs a diagonal dataflow to perform dense matrix multiplication (DMM), specifically described as follows:
assume that a systolic array performs matrix multiplication Y=XWT;
where: YERM×N is an output matrix for each round; XERM×N is an input matrix for each round; WERN×N is a weight matrix for each round; N is an array size; and M is a size of a block in an input row;
the input feeding module acquires an input vector of a length MN and makes same flow into the array from a top-left corner along a direction k; a weight tensor simultaneously flows vertically from top to bottom along a direction j; in addition, a one-cycle delay exists between a weight inputted to an (i+1)-th column and that of an i-th column; N parallel crossbar switch modules are placed orthogonally to the direction k, and each PE module is connected to a local crossbar switch module thereof to obtain an input tensor;
when the input vector reaches a k-th crossbar switch module, each connected PE module performs multiplication between the input along the direction k and the weight along the direction j; after that, the PE module forwards the PSUM to a next PE module along the direction j for accumulation; a bottom PE module stores the PSUM into an output buffer area; where the multiplication is pipelined along the diagonal direction k;
the diagonal dataflow systolic array module employs a diagonal dataflow to perform sparse matrix multiplication; W is sparse, and for a bitmask, 0 and 1 are used to represent zero elements and non-zero elements, respectively; and the bitmask decoder module converts the bitmask into (ID, CAS, MEG);
where ID is a log2N-bit index in an original sparse matrix, and helps the PE module select a corresponding input for computation; CAS is a 1-bit cascade indicator that indicates whether a current PE module cascades and accumulates the PSUM with a PSUM of a previous PE module; and MEG is a 1-bit merge indicator, used to merge cross-column PSUMs;
the non-zero loader module feeds a non-zero weight into an array with corresponding (ID, CAS, MEG); and
when the input flows along the direction k, the PE module performs multiplication according to ID of the weight; the PE module selects any value from the local crossbar switch; after that, the PSUM is forwarded to a next PE module along the direction j, where CAS indicates whether accumulation is performed; and whether to merge the PSUMs outputted from the bottom PE module by MEG is checked.

In a further improvement of this disclosure, the bitmask decoder module includes a bitmask buffer module, a collection module, a decoder FIFO module, and a concatenation module;

the bitmask buffer module is connected to the collection module; the collection module is connected to the decoder FIFO module; and the decoder FIFO module is connected to the concatenation module; and
the collection module is responsible for reading an original bitmask from the bitmask buffer module, and through aggregation operations, concentrating scattered bit information into a lower-order part while setting a higher-order part to 0, and temporarily storing processed data in a decoder FIFO buffer, waiting for further processing; and the concatenation module is configured to decide when to read new data from FIFO on the basis of a weight validity signal, and concatenate the new data with existing data.

In a further improvement of this disclosure, the bitmask decoder module translates the bitmask into an indicator to guide correct sparse computation on the diagonal dataflow systolic array; and an input includes sparse bitmasks from a first row to an N-th row; and the bitmasks are then aggregated into a compact new row;
the collection module acquires the original bitmask from a bitmask buffer, after multiple rounds of continuous aggregation, all the bitmasks are finally concentrated in the lower-order part,
the concatenation module acquires the new row from the FIFO according to the weight validity signal; if a length of the acquired data is insufficient for an output length of the new row, new data is read from the FIFO; after acquiring the data, it determines whether the data meets the length requirement of the new row; if the data does, the data is outputted, and remaining data is continuously and seamlessly concatenated and outputted in sequence.

In a further improvement of this disclosure, the post-processing module includes an activation function module, a SoftMax module, a residual addition module, a layer normalization module, a transpose module, and a rearrangement module;
the activation function module is configured to execute an activation function during the inference process of the large language model;
the SoftMax module is configured to map a value range of data of each node to [0, 1] and constrain a sum of output values of all output nodes to be 1;
the residual addition module is configured to add feature data from a previous step to feature data of a current step during the inference process;
the layer normalization module performs normalization operations on input data to constrain data values within a certain range;
the transpose module is configured to rotate a 32×32 matrix by swapping rows and columns and then save a transposed matrix to the DDR memory module; and
the rearrangement module is configured to rearrange skipped data into a sequential form and then save same as an entire block to the DDR memory module.

In a further improvement of this disclosure, the KV cache module includes an overflow module and a reload module;
the overflow module is configured to manage KV cache overflow and implement a last-in-first-out (LIFO) strategy; and
the reload module is configured to split an on-chip memory into a plurality of blocks, with each block storing a fixed number of token-based KV tensors.

In a further improvement of this disclosure, the overflow module is configured to manage the KV cache overflow and implement the LIFO strategy, including:

when the KV cache continues to grow and exceeds the capacity of the on-chip memory, transferring, by the overflow module, the KV tensors that exceed the capacity to the off-chip DDR memory module; and
during the cross-attention in a decoding stage, since frequent access to KV cache data is required, prioritizing keeping, by the overflow module, the KV tensors from early steps in the on-chip memory, and if space is insufficient, overflowing KV tensors from later steps.

In a further improvement of this disclosure, the reload module is configured to split the on-chip memory into a plurality of blocks, with each block storing the fixed number of token-based KV tensors, including:
splitting the on-chip memory into N blocks, with each block storing M token-based KV tensors; pinning first M×(N−1) token-based KV tensors in first N−1 memory blocks; and always remaining the first M×(N−1) token-based KV tensors on chip to reduce off-chip memory traffic; and
writing a newly generated KV tensor into a last memory block, and once M token-based KV tensors are accumulated in the block, overflowing the memory block to the off-chip memory;
where M is chosen to be equal to the size of the systolic array.

In a second aspect, this disclosure provides an operation method for an accelerator for accelerating inference process of an unstructured sparse large language model, including:
sending, by the computing core module, data requests to the interconnect bus module, and the interconnect bus module being communicated with the DDR memory module to transfer the required data to the computing core module;
converting, by the processor module, a large language model described in a high-level language into specific instructions and weight parameters, and storing the information in the DDR memory module via the direct memory access module;
starting the computing core module to read the instructions and the weight parameters from the DDR memory module, and performing arithmetic operations according to the instruction content; and exchanging, by different computing core modules, data via the router module to jointly complete complex non-linear function computation; and
processing, by the memory controller module, memory read and write requests from the interconnect bus module, and sending the requests to the DDR memory module to ensure that memory access requests from various modules are handled.

### Beneficial Effect

Compared with the prior art, this disclosure has the following beneficial effects:

By the collaborative operation of the interconnect bus module, the computing core module, and the router module, this disclosure breaks the limitations of traditional systolic arrays, where data reuse is confined to a single row or column only, enabling cross-row and cross-column data reuse. Moreover, the use of a diagonal dataflow pattern in this disclosure enhances the data reuse rate and reduces unnecessary memory accesses, thereby lowering memory bandwidth requirements. By utilizing bitmasks to encode the positions of non-zero elements, this disclosure can handle sparse matrices, reducing invalid computations on zero elements and improving computational efficiency. Moreover, this sparse encoding solution reduces off-chip memory traffic and decreases memory access latency. The computing core module in this disclosure acquires data to be computed from the DDR memory module via the interconnect bus module and executes instructions one by one. Data is transferred among computing core modules via the router module, enabling multi-core computation of non-linear functions and further enhancing computational efficiency. The cooperation between the memory controller module and the DDR memory module ensures efficient handling of memory read and write requests. Furthermore, this disclosure pins the early KV cache tensors in on-chip memory, reducing the need for reloading memory traffic and improving memory bandwidth utilization. This strategy also decreases the number of accesses to the off-chip memory and lowers system power consumption. Therefore, this disclosure can more effectively utilize hardware resources, including processors, memory, and computing cores. It reduces the requirements for hardware devices, enabling the inference process of the unstructured sparse large language model to run efficiently on a broader range of hardware platforms. Moreover, the accelerator design in this disclosure has good scalability and flexibility. By adjusting the number and configuration of the computing core modules, it can adapt to unstructured sparse large language models with varying scales and complexities.

### BRIEF DESCRIPTION OF THE DRAWINGS

FIG. 1 is an overall schematic structural diagram of an accelerator for accelerating an inference process of an unstructured sparse large language model according to this disclosure;

FIG. 2 is a schematic structural diagram of a diagonal dataflow systolic array module in an accelerator for accelerating an inference process of an unstructured sparse large language model according to this disclosure;

FIG. 3 is a circuit schematic structural diagram of a PE module and a crossbar switch module in an accelerator for accelerating an inference process of an unstructured sparse large language model according to this disclosure;

FIG. 4 is a schematic structural diagram of a result merging module and a result accumulation module in an accelerator for accelerating an inference process of an unstructured sparse large language models according to this disclosure;

FIG. 5 is a schematic structural diagram of a bitmask decoder module in an accelerator for accelerating an inference process of an unstructured sparse large language model according to this disclosure; and

FIG. 6 is a schematic structural diagram of an overflow module and a reload module in an accelerator for accelerating an inference process of an unstructured sparse large language model according to this disclosure.

### DETAILED DESCRIPTION OF THE EMBODIMENTS

To enable a person skilled in the art to better understand the technical solutions of this disclosure, the technical solutions in the embodiments of this disclosure will be clearly and completely described below with reference to the accompanying drawings in this disclosure, and the described embodiments are only some rather than all of the embodiments of this disclosure. All other embodiments obtained by a person of ordinary skill in the art based on the embodiments of this disclosure without making creative efforts shall fall within the scope of protection of this disclosure.

Unless otherwise defined, all technical and scientific terms used herein have the same meanings as those commonly understood by those skilled in the art of this disclosure. The terms used in this specification of this disclosure are merely for the purpose of describing specific embodiments, but are not intended to limit this disclosure. As used herein, the term “and/or” includes any and all combinations of one or more related listed items.

An unstructured sparse large language model in the prior art, due to the enormous number of parameters and high computational requirements, highly demands on the storage, memory bandwidth, and computational capabilities of hardware devices, and moreover, the irregular sparsity patterns make data reuse challenging, and the current hardware and algorithms offer poor support for the unstructured sparse large language model, leading to the problems of inefficient memory management and low computational efficiency.

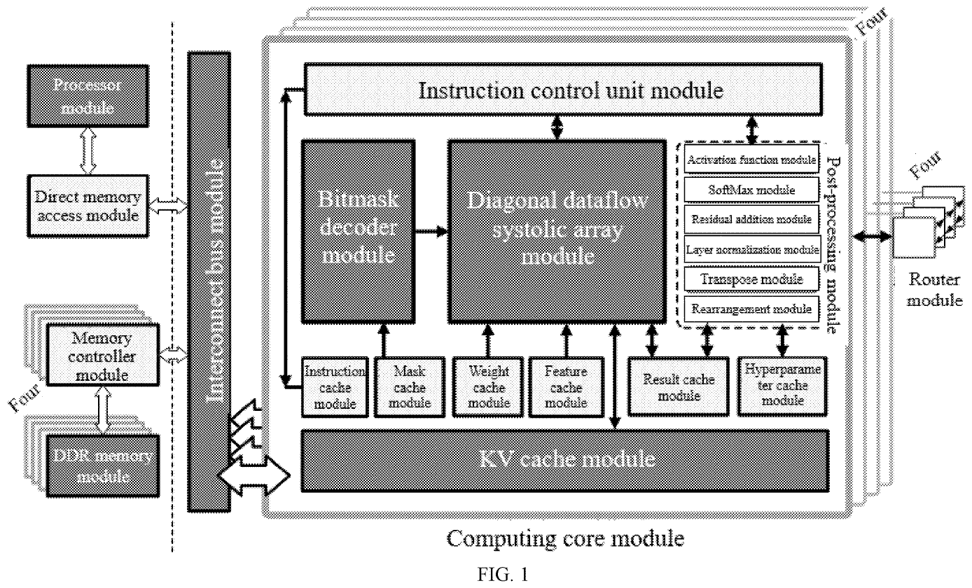

In response to the above-mentioned problems, this disclosure provides an accelerator for accelerating an inference process of an unstructured sparse large language model, as shown in FIG. 1. The accelerator includes a processor module, a direct memory access module, a memory controller module, a DDR memory module, an interconnect bus module, a computing core module, and a router module.

The processor module is interconnected with the direct memory access module; the memory controller module is interconnected with the DDR memory module; the computing core module is interconnected with the router module; the interconnect bus module is simultaneously interconnected with the direct memory access module, the memory controller module, and the computing core module. Specifically, the interconnect bus module is connected to the direct memory access module; the interconnect bus module is connected to the memory controller module; and the interconnect bus module is connected to the computing core module.

There are four memory controller modules, four DDR memory modules, four computing core modules, and four router modules.

During the inference process of the sparse large language model, the computing core module establishes communication links with the external DDR memory module via the interconnect bus module, ensuring that the data to be computed can be transmitted to the computing core module. A processor is responsible for running a compiler during this process, generating corresponding instructions and weight parameters for a large language model, and seamlessly sending this information to the DDR memory module via the direct memory access module. Once the preparations are completed, the computing core module is activated to read instructions from the DDR memory module and execute same one by one to advance the inference process of the model. To enhance computational efficiency and handle complex operations, computing core modules can exchange data with each other via the router module. This design not only supports linear computations but also enables multi-core parallel computation of non-linear functions, thereby boosting the speed and performance of model inference.

The processor module is configured to run a software compiler, break down the unstructured sparse large language model into basic operators and processes, and generate a hardware-executable machine code according to an instruction set definition. When handling weight parameters, the processor module arranges the weight parameters in an orderly manner according to node addresses. This arrangement helps improve memory access efficiency, and reduces the time overhead of data transmission, thereby enhancing overall computational performance. For each computing core module, the processor generates a corresponding hexadecimal txt file. These files contain all the instructions and operands required for execution by the core and serve as the foundation for the computing core to perform model inference.

The direct memory access module is configured to fulfill data loading and saving requests issued by the processor module, enabling direct data transmission to the DDR memory module via the interconnect bus module. This design allows data to move quickly between memory and processor without the involvement of a central processing unit, thereby freeing up processor resources and improving the overall performance of the accelerator.

The memory controller module is configured to handle memory read and write requests from the interconnect bus module and convert these requests from the Advanced extensible Interface (AXI) protocol to the Double Data Rate Synchronous Dynamic Random Access Memory (DDR) protocol. This conversion process is crucial for ensuring the correct and efficient transmission of data between other modules and the DDR memory.

Firstly, the memory controller module receives memory read and write requests in AXI protocol format from the interconnect bus module, and then parses these requests to extract the request type, address information, and data content. Subsequently, the parsed AXI protocol requests are converted into DDR protocol requests. The converted DDR protocol requests are sent to the DDR memory module for actual read and write operations. After completing the memory access operations, the memory controller module receives responses from the DDR memory module and converts same from the DDR protocol back to the AXI protocol. Finally, the processed results are returned to the interconnect bus module that initiates the request.

The interconnect bus module is configured to connect the direct memory access module, the memory controller module, and the computing core modules, achieving data transmission among these modules and arbitrating multi-port access.

The interconnect bus module can accurately and swiftly route data from the source to the destination on the basis of requests from various modules. When a plurality of modules attempt to access the same resource simultaneously, the interconnect bus module is responsible for access arbitration, ensuring the orderly and fair allocation of access rights and preventing conflicts and deadlocks. The interconnect bus module also has bandwidth management capabilities, can dynamically adjust the bandwidth allocation of each data channel according to the real-time system load, to achieve optimal overall performance, and can also detect and trigger error recovery operations during data transmission, to ensure the reliability of data transmission and the stability of the system.

The router module is configured for data synchronization operations among different computing core modules. Each computing core module is equipped with a router module. One router module is connected not only to a corresponding computing core module thereof but also to an adjacent router module. Each computing core module is equipped with a dedicated router module, enabling efficient data communication and synchronization operations among different computing core modules, thereby enhancing the overall computational capability and data processing efficiency of the system.

The router module can receive data from the corresponding computing core module thereof and forward the data to other computing core modules that require the information. In a multi-core parallel computing environment, different computing core modules may need to perform synchronization operations to ensure the correctness and consistency of computation. The router module supports various synchronization mechanisms, including but not limited to barrier synchronization and event synchronization.

Each router module is connected not only to the corresponding computing core module thereof but also to other adjacent router modules, forming a network. This network design can employ various topologies, including ring, tree, and mesh. Furthermore, the router module has flow control and congestion avoidance mechanisms, can monitor network load during data transmission and take measures to prevent data congestion and packet loss, ensuring stable network operation. Additionally, fault tolerance is considered, enabling the accelerator to continue operating or resume normal operation after fault recovery in the event of failures in some routers or computing core modules.

The computing core module is configured to execute the inference process of the unstructured sparse large language model, receive a start control signal from the processor module and then read instructions and weight parameters from the DDR memory module. During the inference process, the computing core module also writes some intermediate results to the DDR memory module until the entire inference is completed, and store the final results back in the DDR memory module, at which point the processor module can read the inference results via the direct memory access module.

During the inference process of the sparse large language model, the computing core module is responsible for executing the instruction sequences compiled and issued by the processor module. Each computing core module possesses powerful parallel computing capabilities and a highly optimized algorithm library, to meet the complex computational requirements in the inference process of the large language model.

Before the inference process begins, the computing core module remains in a standby state. Upon receiving the start control signal from the processor module, the computing core module starts reading instructions and corresponding weight parameters from the DDR memory module. Subsequently, the computing core module sequentially executes various arithmetic and logical operations according to the read instruction sequences. During execution, the computing core module also shares intermediate results with other modules to support more complex computations and algorithms. At different stages of the inference process, the computing core module writes some intermediate results back to the DDR memory module. This helps disperse the pressure of data processing and ensures data consistency and availability during long-cycle inference processes. When all instructions are executed, the computing core module stores the final inference results in a designated area of the DDR memory module. At this point, the computing core module sends a completion signal to the processor module, indicating that the inference process is ended. Upon receiving the completion signal, the processor module can read the inference results from the DDR memory module via the direct memory access module. These results can then be used for subsequent processing tasks, such as result analysis and decision-making.

The computing core module includes: an instruction control unit module, a bitmask decoder module, a diagonal dataflow systolic array module, a post-processing module, an instruction cache module, a mask cache module, a weight cache module, a feature cache module, a result cache module, a hyperparameter cache module, and a KV cache module.

As shown in FIG. 1, the instruction control unit module is simultaneously interconnected with the instruction cache module, the diagonal dataflow systolic array module, and the post-processing module; the bitmask decoder module is simultaneously connected to both the mask cache module and the diagonal dataflow systolic array module; the diagonal dataflow systolic array module is connected to the bitmask decoder module, the weight cache module, the feature cache module, the KV cache module, and the result cache module; and the post-processing module is simultaneously connected to both the result cache module and the hyperparameter cache module.

The processor module runs a software compiler to generate instructions for the sparse large language model and sends same to the DDR memory module via the direct memory access module. The instruction control unit module acquires instructions from the instruction cache module and prepares for executing same. The computing core module acquires data from the weight cache module and the feature cache module. The data are then fed into the diagonal dataflow systolic array module for dense or sparse matrix computations. During this process, the bitmask decoder module performs necessary translation work for unstructured sparsity. The computation results are initially saved to the result cache module. Subsequently, the computation results are further processed by the post-processing module, such as performing nonlinear operations. The processed results are subsequently saved back to the DDR memory module, ready for the next round of computation or for use by other system components. The aforementioned process is iteratively executed for multiple rounds according to the specific requirements of the model. Throughout the inference process, the system reduces data access latency and enhances computational efficiency through optimized data paths and efficient cache management strategies, thereby accelerating the inference process of the large language model. The hyperparameter cache module is configured to store and manage various hyperparameters required during the model inference process. When performing its functions, the post-processing module references certain hyperparameters from the hyperparameter cache module to adjust processing strategies.

The processor module runs a software compiler to generate instructions for the sparse large language model and sends same to the DDR memory module via the direct memory access module. The computing core module executes the inference process of the sparse large language model. Each time, the computing core module acquires data from the weight cache module and the feature cache module and feeds the data into the diagonal dataflow systolic array module for dense or sparse matrix computations, with the bitmask decoder module performing translations for unstructured sparsity. An output is saved to the result cache module and can then be passed to the post-processing module for nonlinear operations. The results are then sent back to the DDR memory module. This multi-round execution process accelerates the inference of the large language model.

The instruction control unit module is configured to control a behavior of each module within the computing core module during operation. During each computational cycle, a plurality of instructions are acquired from the instruction cache module to form an instruction block, which is then decoded into values for each register. At the start of each computational cycle, the instruction control unit module acquires an instruction block from the instruction cache module. This instruction block contains several instructions that collectively form the operational guide for the subsequent computational cycle. After obtaining the instruction block, the instruction control unit module decodes the instruction block, translates the instructions into operations for sub-modules within the computing core module, thereby controlling the specific behaviors of the sub-modules within the computing core module.

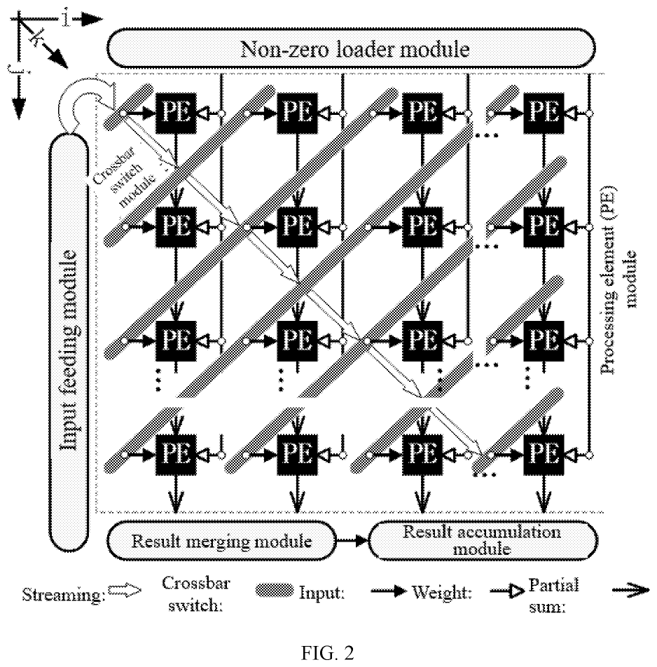

As shown in FIG. 2, the diagonal dataflow systolic array module is configured to perform sparse-dense matrix multiplication and dense-dense matrix multiplication operations for the unstructured sparse large language model.

The diagonal dataflow systolic array module includes an input feeding module, a non-zero loader module, a PE module, a crossbar switch module, a result merging module, and a result accumulation module.

The input feeding module is connected to a first-stage crossbar switch module in a top-left corner; the non-zero loader module is connected from a top to data lines of each column of the PE module; each stage of the crossbar switch is connected to the PE modules on a diagonal where the crossbar switch is located, and is connected to crossbar switch modules of adjacent preceding and following stages; each PE module is connected to crossbar switches on a diagonal and is connected to upper and lower adjacent PE modules in a same column; and the result merging module is connected to PE modules in a last row and is connected to the result accumulation module.

The diagonal dataflow systolic array module enables efficient data reuse for both dense and sparse computation modes. Data is acquired from the input feeding module and then arranged into a staggered format required by the array through streamlined organization. The non-zero loader module collaborates with the bitmask decoder module to match weights with masks and feed same into the array. Here, input feature data enters from the top-left corner and is fed downwards each time. Weights flow in from the top and are permanently stored within the PE module. The PE module acquires the required feature data from the crossbar switch module on the basis of the ID of the weight, performs multiply-accumulate operations, and determines whether to accumulate the output result from the preceding PE module. A column result from each PE module is outputted downwards to the result merging module, where cross-column accumulation is performed in the result accumulation module. PSUM undergoes multiple rounds of accumulation to produce the final result.

When processing a sparse matrix, the non-zero loader module works in tandem with the bitmask decoder module to ensure that the weights and masks are properly fed into the array. Input feature data enters from the top-left corner and propagates downwards sequentially, while weights flow in from the top and are permanently stored within the PE module. The PE module is the core component of the systolic array, acquires the required feature data from the crossbar switch module on the basis of the ID number of the weight and performs multiply-accumulate operations. Moreover, the PE module is responsible for determining whether to accumulate the output result from the preceding PE module. The results from each PE module are outputted downwards to the result merging module, where cross-column accumulation is performed in the result accumulation module. The final result is obtained through multiple rounds of accumulation. By leveraging efficient input/output mechanisms and collaboration among PE modules, the diagonal dataflow systolic array module enables effective processing of both dense and sparse computation modes, enhancing computational efficiency and performance.

For DMM executed using diagonal dataflow, the specific implementation is as follows.

Assume that a systolic array performs matrix multiplication Y=XWT;
where: YERM×N is an output matrix for each round; XERM×N is an input matrix for each round; WERN×N is a weight matrix for each round; N is an array size; and M is a size of a block in an input row.

As shown in FIG. 2, at the start of each computational cycle, the input feeding module acquires an input vector of a specified length MN and simultaneously flows same into the array from the top-left corner along a direction k. A weight tensor flows vertically downwards along a direction j. Additionally, a one-cycle delay exists between a weight fed into an (i+1)-th column and that of an i-th column. N parallel crossbar switch modules are placed orthogonally to the direction k, with each PE module connected to a local crossbar switch module thereof to acquire an input tensor (as needed). When the input vector reaches a k-th crossbar switch module, each connected PE module performs multiplication between the input along the direction k and the weight along the direction j. Subsequently, the PE module forwards the PSUM to a next PE module along the direction j for accumulation. Finally, the bottom PE module stores the PSUM in an output buffer area. Moreover, multiplication operations are pipelined along the diagonal direction k.

For sparse matrix-matrix multiplication (SpMM) using diagonal dataflow, given the sparsity of W, the systolic array design supporting SpMM ensures that corresponding elements are multiplied and accumulated while keeping the PE module as busy as possible. Before each computational cycle, for a bitmask, 0 and 1 are used to represent zero elements and non-zero elements, respectively. The bitmask decoder module converts the bitmask into (ID, CAS, MEG), where ID is a log2N-bit index in an original sparse matrix, and helps the PE modules select a corresponding input for computation; CAS is a 1-bit cascade indicator that indicates whether a current PE module cascades and accumulates the PSUM with a PSUM of a previous PE module; and MEG is a 1-bit merge indicator, used to merge cross-column PSUMs.

A non-zero loader feeds a non-zero weight into an array with corresponding (ID, CAS, MEG). When the input flows along the direction k, each PE module performs multiplication on the basis of the ID of the weight. Each PE module can select any value from a local crossbar switch thereof, ensuring sufficient input bandwidth and keeping the PE module continuously busy. Subsequently, the PSUM is forwarded along the direction j to the next PE module, where CAS indicates whether accumulation is performed. This enables a plurality of compressed weight columns to be compressed into the same PE module column while sharing input. Finally, a check is performed to determine whether PSUM outputted by the MEG from the bottom PE module needs to be merged.

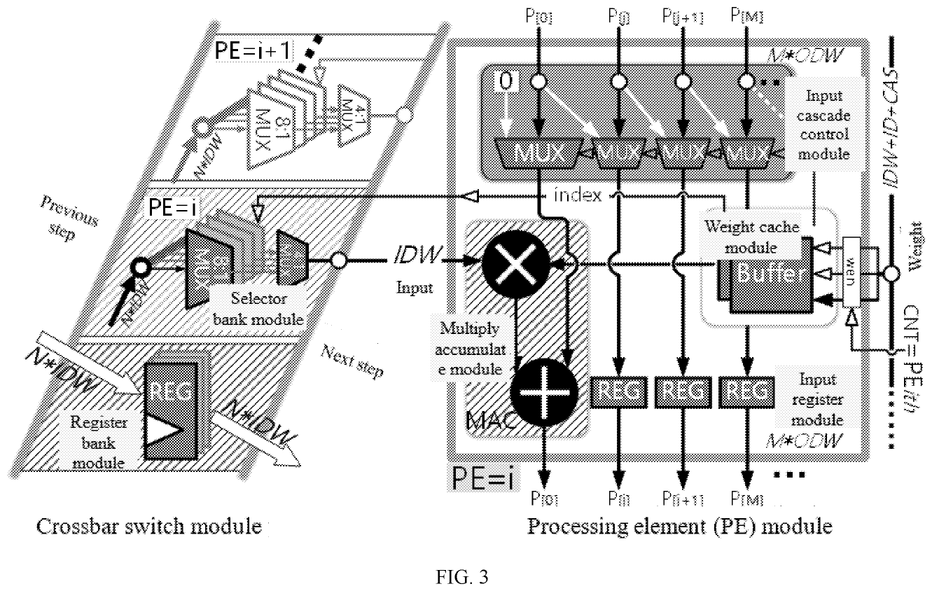

As shown in FIG. 3, the PE module receives updated weights, ID numbers, and cascade enable from the left-side branch and stores same in the weight cache module. Here, the cascade is configured to control the connection between the input and the multiplier-accumulator (MAC), to determine whether to accumulate the output from the previous PE module. The ID number is sent to the crossbar switch to select one piece of required data from N pieces of data. The crossbar switch module feeds the selected data into a register for the next computational cycle.

The crossbar switch module includes: a register bank module and a selector bank module.

The input data is connected to both the register bank module and the selector bank module for subsequent processing.

For sparse computation, the crossbar switch module needs to broadcast an input vector and select corresponding data on the basis of the given ID number from the bitmask decoder module. Since each crossbar switch module is a selector bank module with a large number of inputs, the register is inserted to form a multi-stage pipeline for improved timing closure. For dense computation, because data reuse is pinned, the crossbar switch module can be bypassed and connected to a pinned port, to save power consumption caused by input selection.

The PE module includes: a multiply accumulate module, a PE weight cache module, an input cascade control module and an output register module.

The PE weight cache module is connected to both the multiply accumulate module and the input cascade control module. The input cascade control module and the multiply accumulate module are connected to the output register module.

To accommodate unstructured sparse computation with variable-length accumulation sizes, a PE module having reconfigurable input and PSUM data flow control is employed. Each PE module is connected to the local crossbar switch module thereof via an input data width (IDW)+ID+CAS bit bus, to receive input, index, and cascade indicator. To update weights for each PE module, a counter is used to scan from 1 to N. When the counter matches the index in the PE module, the PE weight cache module is updated. After computation, the PE module reads the [ID] number of the index from the buffer area, and sends same to the local crossbar switch module to select the required value from the N elements of the input vector. Then, the data is fed into a DSP48E2-based hard MAC-IP multiply accumulate module for executing multiply-accumulate operations. Afterward, the [CAS] token is utilized to determine whether to adopt the PSUM value from the upper adjacent PE module and switch the connection path of the cascaded chain. When [CAS] is valid, it maintains a cascaded chain; otherwise, it connects to the bypass path, where the input P[j] is registered into MEG[j+1] and is connected to the output P[j+1]. Since the PCIN of the MAC is unused, the result is connected to the output P[0]. The PSUM flows vertically from top to bottom, with accumulation controlled by a cascade indicator. A plurality of PSUMs can be outputted on a single PE column, in which case the PSUMs are shifted to a port P and are collectively outputted at the bottom PE. Therefore, flexible sparsity rates can be supported by configuring the bitwidth of P[0:M−1] and the number of registers. For example, sparsity rates of 0%, 50%, 33%, and 25% can be supported with values of M=1, 2, 3, and 4, respectively.

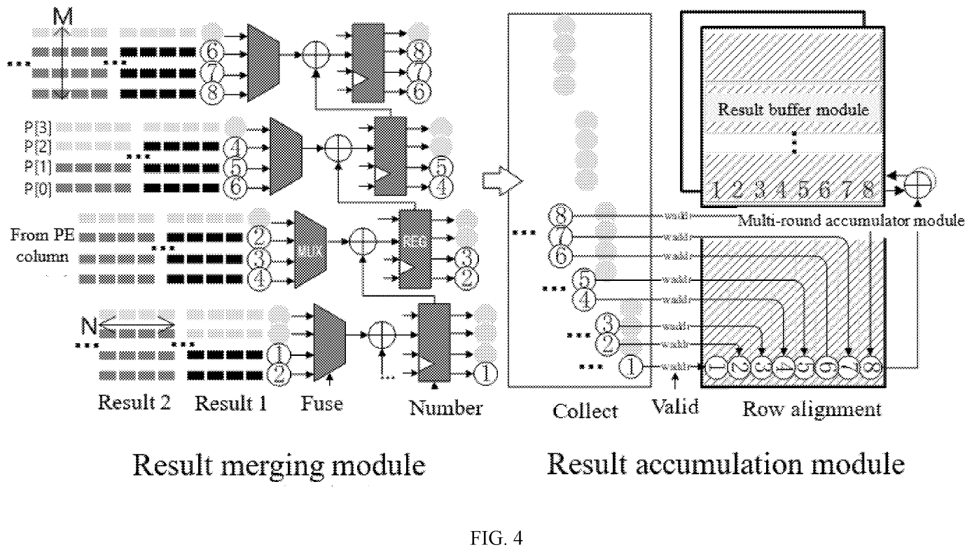

As shown in FIG. 4, the result merging module combines different results from the PE module by aligning the highest and lowest bits of adjacent outputs, collecting data toward lower bits, and performing row alignment on the basis of valid bit information. Finally, the entire line of data is stored in the result cache module, where the results of previous step and new values need to be read for in-place accumulation.

According to sparse coding, the result merging module allows non-zero values originally from the same column to be arranged on two PE columns (PEcols). Each PEcol in the array can output MxPSUM. For example, when M=4, an index thereof represents the original column. If PEcol[0] outputs “1” and “2”, and PEcol[1] outputs “2”, “3”, and “4”, it means that P[2] and P[0] originally come from the same column “2” and need to be merged. Since there is a one-cycle difference between PEcol[i] and PEcol[i+1], the previous data can be retained in the register. MEG indicates which of the M entries is to be merged. PEcol[i] sends the lower-order P[0] to the higher-order P[MEG] of PEcol[i+1], which matches the width of the PSUM buffer area. MEG is hierarchically collected and compared from the local to the global level. The valid signal enables the write address for each port. Elements from different cycles are temporarily cached in a distributed random-access memory (RAM) to align the entire row.

The result accumulation module is configured to send the aligned result data to the multi-round accumulator module and write same to the specified address in the PSUM buffer area. To avoid conflicts, the buffer area is designed with a dual-ping-pong structure. For dense computation, no merging is required, so only the P[0] port of each PEcol is used.

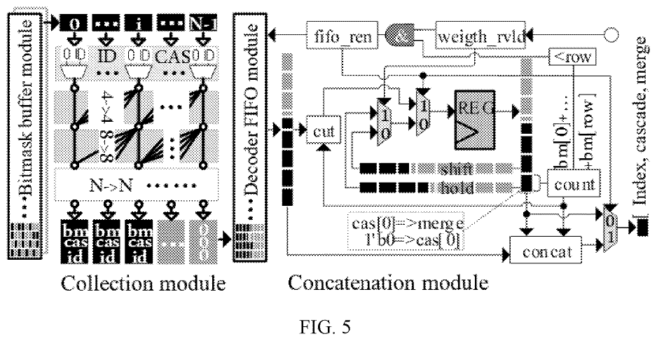

As show in FIG. 5, the bitmask decoder module is used to decode a bitmask matrix of an unstructured sparse large language model, translate position information before sparsification, to obtain a position of the position information before sparsification in an original matrix. Additionally, an index value register, a cascade value register, and a merging value register are attached to each weight. These registers are collectively fed into a diagonal dataflow systolic array module to control the computational behavior of each PE within the PE module.

The bitmask decoder module receives a sparsified bitmask matrix. The task of the bitmask decoder module is to interpret the bitmasks and restore the position information of non-zero elements in the original data. This is particularly crucial for handling large sparse matrices. By utilizing the decoded bitmask information, when each PE in the PE module executes computations and how it processes the input data are controlled. This control mechanism ensures the efficient processing of sparse matrices.

The bitmask decoder module includes a bitmask buffer module, a collection module, a decoder FIFO module, and a concatenation module.

The bitmask buffer module is connected to the collection module. The collection module is connected to the decoder FIFO module, and the decoder FIFO module is connected to the concatenation module.

In a sparse matrix, the position of each non-zero element is encoded using a 1-bit mask. The bitmask decoder module is configured to convert a binary mask into (ID, CAS, MEG), to control the behavior of PE module. Each bitmask contains n rows of information.

First, the number of first non-zero elements in each row is first collected to generate ID.

The aligned non-zero elements are uniformly distributed to different PE modules, so when the non-zero elements are assigned to different PE module groups, the MEG is set to 1.

The CAS is set to 0 on the basis of two criteria: either the element is the first non-zero element in its row, or the MEG is set to 1; otherwise, CAS is set to 1.

The collection module is configured to read bitmasks with a bitwidth of [0:N−1] from the bitmask buffer module during each computation cycle. A tree-structured decoder traverses several levels to locate the position of 1, following a pattern of in-4→out-4, in-8→out-8, up to in-N→out-N, as shown in FIG. 5. All the non-zero elements are arranged in big-endian format and are stored into the decoder FIFO module.

The concatenation module uses a counter and a shift register to acquire aligned non-zero elements from the decoder FIFO module. If the counter indicates sufficient non-zero elements, the non-zero elements are outputted directly. Otherwise, new items are read from the decoder FIFO module and are concatenated into the shift register.

Therefore, the collection module is responsible for reading the original bitmask from the bitmask buffer and performing a series of aggregation operations to concentrate the scattered bit information into the lower-order bits, while setting the higher-order bits to 0. The processed data is temporarily stored in the decoder FIFO buffer, waiting for further processing. The concatenation module determines when to read new data from the FIFO on the basis of the weight validity signal, and concatenates same with existing data. This process involves determining the length of the new data and figuring out how to temporarily store the partial data with insufficient length in a shift register for seamless concatenation in subsequent steps.

The bitmask decoder module translates the bitmask into ID, CAS, and MEG indicators to guide correct sparse computation on a diagonal dataflow systolic array. The input consists of sparse bitmasks spanning rows 1 to N, which are aggregated into a compact new row. The collection module acquires the original bitmask from the bitmask buffer and, through multiple rounds of continuous aggregation, ultimately concentrates all the bit information into the leftmost lower-order bits, with the higher-order bits set to 0. The processed result is then stored in the decoder FIFO buffer. The concatenation module on the right side acquires the new row from the FIFO on the basis of the weight validity signal. If the data is not sufficient to meet the output length of the new row, it reads new data from the FIFO. After obtaining the data, it determines whether the data length is enough for a new row according to the counter value. If it is sufficient, the data is outputted, and the remaining data is saved into the shift register for seamless, continuous concatenation in subsequent cycles.

The post-processing module is configured to perform non-linear operations and special data conversion processes in the large language model.

The post-processing module includes an activation function module, a SoftMax module, a residual addition module, a layer normalization module, a transpose module, and a rearrangement module.

The residual addition module is connected to the layer normalization module. The remaining modules are connected in parallel to inputs/outputs of the port.

The activation function module is configured to execute activation functions for the inference process of the large language model, including exponential (EXP) and Gaussian error linear unit (GELU) functions. The SoftMax module is configured to map node values to the range [0, 1] while constraining the sum of all output nodes to 1. The residual addition module is configured to combine feature data from the previous inference step with the feature data of the current step. The layer normalization module performs normalization on input data to constrain values within a specified range. The transpose module is configured to rotate a 32×32 matrix by swapping rows and columns, and then store the transposed matrix in DDR memory module. The rearrangement module is configured to rearrange skipped data into sequential form before saving same as an entire block in the DDR memory module.

The post-processing module is configured to perform non-linear operations and special data conversion processes. In addition to nonlinear operations, the post-processing module can also perform special data conversion such as matrix transposition, matrix factorization, and feature normalization, which are critical for improving model accuracy and performance.

The instruction cache module is configured to cache instructions during the model inference process, for acquiring by the instruction control unit module. Whenever the cache is nearly depleted, corresponding data is read from the DDR memory module to update the cache.

The instruction cache module can store a portion of the instructions used during the model inference process, enabling rapid provision to the instruction control unit module. When the instructions in the instruction cache module are about to be exhausted, it automatically reads the corresponding data from the DDR memory module to refresh the cache, ensuring instruction continuity and correctness. The primary role of the instruction cache module is to reduce the frequency of access to the DDR memory, thereby lowering system power consumption and latency. Additionally, the instruction cache module can accelerate instruction access, thereby enhancing execution efficiency and performance of the processor.

The mask cache module is configured to cache a bitmask matrix of the unstructured sparse large language model before compression for acquiring by the bitmask decoder module, and read data from the DDR memory module for updating in each round of computation.

The mask cache module can cache a portion of uncompressed bitmask matrices to provide same rapidly to the bitmask decoder module. During each computational cycle, the mask cache module reads corresponding data from the DDR memory module to update cache, ensuring continuity and correctness of the bitmask matrices. The primary function of the mask cache module is to reduce the frequency of access to the DDR memory module, thereby lowering system power consumption and latency. Additionally, the mask cache module can accelerate the access speed of the bitmask matrices, thereby enhancing the execution efficiency and performance of the bitmask decoder module.

The weight cache module is configured to cache weight parameters of the unstructured sparse large language model after compression, serving as a left-hand matrix to be multiplied in a diagonal dataflow systolic array.

The feature cache module is configured to cache feature map data inputted by users of the large language model, and the feature map data is fed into a right-hand matrix to be multiplied in the diagonal dataflow systolic array module.

The result cache module is configured to cache PSUM results after the multiplication in the diagonal dataflow systolic array and perform cyclic accumulation for multiple rounds of matrix multiplications. After completion, the results are saved to an off-chip DDR memory module or an on-chip KV cache module.

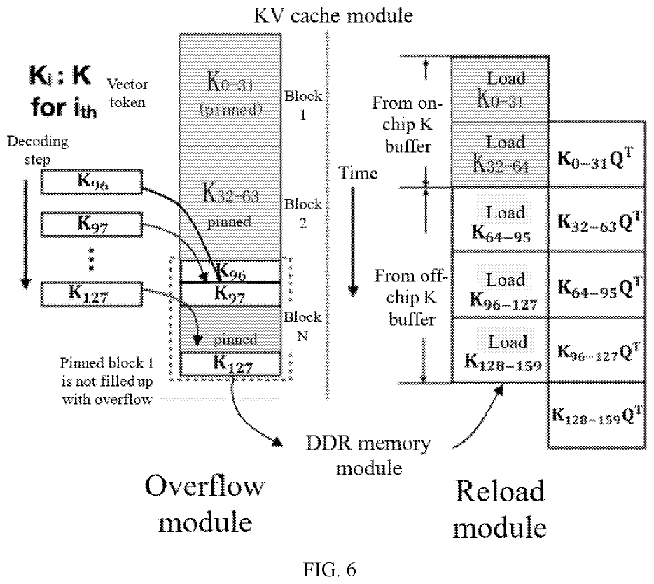

As shown in FIG. 6, a KV cache module is configured to cache K and V matrices during a generation phase in an inference process of the large language model, and the K and V matrices are used when generating a next word.

The KV cache module includes: an overflow module and a reload module.

The overflow module and the reload module are connected to the DDR memory module.

Since the KV caches continuously grow and the limited on-chip memory cannot always accommodate all the KV caches, the overflow module serves for spilling the KV caches to an off-chip memory and reloading same during a next decoding step for computation. This process generates significant off-chip memory traffic during the cross-attention phase of the decoding stage. Considering that each KV tensor remains active until the end of the conversation, KV tensors from earlier steps are always retained in the on-chip memory, and KV tensors from later steps are spilled when space is insufficient. Therefore, a simple yet effective on-chip allocation solution for KV caches is employed, that is, the KV tensors from earlier steps are pinned in the on-chip memory, and an LIFO strategy is used to spill the KV tensors from later steps. Therefore, the KV tensors are spilled with a block size that includes M token-based KV tensors.

The reload module is configured to split an on-chip memory into a plurality of blocks, with each block storing M token-based KV tensors. The first M×(N−1) token-based KV tensors are pinned to the first N−1 memory blocks, and permanently remain on chip to reduce off-chip memory traffic. In addition, the newly generated KV tensors are written into the last memory block. Once this block accumulates M token-based KV tensors, the memory block will spill the KV tensors over to the off-chip memory. The value of M is chosen to match the size of the systolic array, enabling efficient overlap between block reloading and computation, and merging the accesses to the KV cache memory. Due to CAS latency, off-chip memory access requests for small vectors incur significant delay overheads. Therefore, KV tensors are reloaded in block form to prevent performance degradation.

For block-wise overflow and bulk reloading, the overflow module and the reload module employ an LIFO strategy. On the left side, there is the overflow rule: K vectors are cached, and only when 32 are accumulated will they overflow as an entire block to the off-chip memory. On the right side, it is the earlier blocks needed again, and a plurality of blocks are reloaded in a single operation.

In summary, in traditional systolic arrays, data can only be reused along a single row or column. In this disclosure, a diagonal dataflow systolic array is used, enabling data reuse along diagonal directions and achieving cross-row and cross-column data reuse, thereby enhancing computational efficiency and hardware utilization. In addition, the diagonal dataflow systolic array results in small area overhead, as it only requires the integration of a small amount of logic and memory resources into the existing systolic array.

For pruned LLM parameters, this disclosure employs bitmask to encode the positions of non-zero elements, thereby reducing off-chip memory traffic to a maximum extent. Furthermore, by utilizing the bitmask decoder module for decoding, detailed value indices and accumulation metrics can be rapidly obtained during operation, thereby enhancing both computational efficiency and hardware utilization.

Finally, this disclosure employs a method involving pinning early KV cache tensors in an on-chip memory to reduce reload-related memory traffic. Additionally, a method merging memory accesses is used to enhance memory bandwidth utilization. The advantages lie in its ability to effectively reduce the frequency of the access to the off-chip memory, thereby lowering memory latency and power consumption.

It is to be noted that in this disclosure, there are four memory controller modules, four DDR memory modules, four computing core modules, and four router modules, which can be increased or decreased according to actual requirements.

A second objective of this disclosure lies in providing an operation method for an accelerator for accelerating an inference process of an unstructured sparse large language model, including:
sending, by the computing core module, data requests to the interconnect bus module, and the interconnect bus module being communicated with the DDR memory module to transfer the required data to the computing core module;
converting, by the processor module, a large language model described in a high-level language into specific instructions and weight parameters, and storing the information in the DDR memory module via the direct memory access module;
starting the computing core module to read the instructions and the weight parameters from the DDR memory module, and performing arithmetic operations according to the instruction content; and exchanging, by different computing core modules, data via the router module to jointly complete complex non-linear function computation; and
processing, by the memory controller module, memory read and write requests from the interconnect bus module, and sending the requests to the DDR memory module to ensure that memory access requests from various modules are handled.

Upon reading the above description, numerous embodiments and applications beyond the provided embodiments would have been obvious to a person skilled in the art. Therefore, the scope of this teaching is not to be determined solely by reference to the foregoing description but rather by the preceding claims and the full scope of all equivalents of the claims. For completeness, all articles and references, including the publication of patent applications and announcements, are incorporated herein through reference. The omission of any aspect of the disclosed subject matter in the preceding claims is not intended to waive such content nor is it to be construed as the failure of the applicant to consider such subject matter as part of the disclosed disclosure.

The foregoing further describes this disclosure, and cannot be concluded that the implementation of this disclosure is limited thereto. Those of ordinary skill in the art can make various inferences or substitutions without departing from the concept of this disclosure, and all such inferences and substitutions are to be deemed to fall within the protection scope defined by the claims of this disclosure.

What is claimed is:

1. An accelerator for accelerating an inference process of an unstructured sparse large language model, comprising: a processor module, a direct memory access module, a memory controller module, a double-data-rate (DDR) memory module, an interconnect bus module, a computing core module, and a router module, wherein
the interconnect bus module is connected to the direct memory access module, the memory controller module, and the computing core module; the processor module is connected to the direct memory access module; the DDR memory module is connected to the memory controller module;
and the router module is connected to the computing core module and an adjacent router module;
the computing core module acquires data to be computed from an off-chip DDR memory module via the interconnect bus module;
a processor runs a compiler to generate instructions and weight parameters for a large language model, and sends the instructions and the weight parameters to the DDR memory module via the direct memory access module; and then the computing core module acquires the instructions and executes same one by one;
the computing core module transfers data with each other via the router module to achieve multi-core computation of a non-linear function; and the computing core module acquires the data to be computed from the DDR memory module via the interconnect bus module;
the memory controller module processes memory read and write requests from the interconnect bus module and sends the memory read and write requests to the DDR memory module; wherein
the computing core module comprises: an instruction control unit module, a bitmask decoder module, a diagonal dataflow systolic array module, a post-processing module, an instruction cache module, a mask cache module, a weight cache module, a feature cache module, a result cache module, a hyperparameter cache module, and a KV cache module;
the processor module runs a software compiler to generate instructions for a sparse large language model and sends the instructions to the DDR memory module via the direct memory access module; the instruction control unit module acquires the instructions from the instruction cache module and prepares for execution; the computing core module acquires data from the weight cache module and the feature cache module and feeds the data into the diagonal dataflow systolic array module for dense or sparse matrix computation; computation results are saved to the result cache module and are processed by the post-processing module; and processed results are then saved to the DDR memory module for a next round of computation or for use by other system components;
the instruction control unit module is configured to control a behavior of each module within the computing core module during operation;
the bitmask decoder module is configured to decode a bitmask matrix of an unstructured sparse large language model, translate position information before sparsification, to obtain a position of the position information before sparsification in an original matrix, and feed translation results to the diagonal dataflow systolic array module;
the diagonal dataflow systolic array module is configured to perform sparse-dense matrix multiplication and dense-dense matrix multiplication operations for the unstructured sparse large language model;
the post-processing module is configured to perform non-linear operations and special data conversion processes in the large language model;
the instruction cache module is configured to cache instructions during a model inference process for acquiring by the instruction control unit module;
the mask cache module is configured to cache a bitmask matrix of the unstructured sparse large language model before compression for acquiring by the bitmask decoder module, and read data from the DDR memory module for updating in each round of computation;
the weight cache module is configured to cache weight parameters of the unstructured sparse large language model after compression, serving as a left-hand matrix to be multiplied in the diagonal dataflow systolic array module;
the feature cache module is configured to cache feature map data inputted by users of the large language model, and the feature map data is fed into a right-hand matrix to be multiplied in the diagonal dataflow systolic array module;
the KV cache module is configured to cache K and V matrices during a generation phase in an inference process of the large language model, and the K and V matrices are used when generating a next word;
the result cache module is configured to cache partial sum (PSUM) results after the multiplication in a diagonal dataflow systolic array and perform cyclic accumulation for multiple rounds of matrix multiplications, and after completion, the results are saved to the off-chip DDR memory module or an on-chip KV cache module; and
the diagonal dataflow systolic array module comprises an input feeding module, a non-zero loader module, a processing element module, a crossbar switch module, a result merging module, and a result accumulation module, wherein the input feeding module is connected to a first-stage crossbar switch module; the non-zero loader module is connected from a top to data lines of each column of the processing element module; each stage of the crossbar switch is connected to processing element modules on a diagonal where the crossbar switch is located, and is connected to crossbar switch modules of adjacent preceding and following stages; each processing element module is connected to crossbar switch modules on a diagonal and is connected to adjacent upper and lower processing element modules in a same column; and the result merging module is connected to processing element modules in a last row and is connected to the result accumulation module.

2. The accelerator for accelerating the inference process of the unstructured sparse large language model according to claim 1, wherein in the input feeding module, data is acquired and arranged in a streamlined organization into a staggered form required by an array; the non-zero loader module cooperates with the bitmask decoder module to feed matched weights and masks into the array together; wherein input feature data is inputted from a top-left corner and is fed downwards each time; the weights flow in from the top and are pinned and stored within the processing element module; the processing element module obtains the required feature data from the crossbar switch module according to ID numbers of the weights, performs multiply-accumulate operations, and decides whether to accumulate an output result of a previous processing element module; and a column result of each processing element module is outputted downwards to the result merging module, cross-column accumulation is performed in the result accumulation module, and then PSUM is accumulated over multiple rounds to obtain a final result.

3. The accelerator for accelerating the inference process of the unstructured sparse large language model according to claim 1, wherein the diagonal dataflow systolic array module employs a diagonal dataflow to perform dense matrix multiplication, specifically described as follows:
assume that a systolic array performs matrix multiplication Y=XWT;
where: YERMxN is an output matrix for each round; XERMxN is an input matrix for each round; WERNXN is a weight matrix for each round; N is an array size; and M is a size of a block in an input row;
the input feeding module acquires an input vector of a length MN and makes same flow into the array from a top-left corner along a direction k; a weight tensor simultaneously flows vertically from top to bottom along a direction j; in addition, a one-cycle delay exists between a weight inputted to an (¿+1)-th column and that of an i-th column; N parallel crossbar switch modules are placed orthogonally to the direction k, and each processing element module is connected to a local crossbar switch module thereof to obtain an input tensor;
when the input vector reaches a k-th crossbar switch module, each connected processing element module performs multiplication between the input along the direction k and the weight along the direction j; after that, the processing element module forwards the PSUM to a next processing element module along the direction j for accumulation; a bottom processing element module stores the PSUM into an output buffer area; wherein the multiplication is pipelined along the diagonal direction k;
the diagonal dataflow systolic array module employs a diagonal dataflow to perform sparse matrix multiplication; W is sparse, and for a bitmask, 0 and 1 are used to represent zero elements and non-zero elements, respectively; and the bitmask decoder module converts the bitmask into (ID, CAS, MEG);
where ID is a log2N-bit index in an original sparse matrix, and helps the processing element module select a corresponding input for computation; CAS is a 1-bit cascade indicator that indicates whether a current processing element module cascades and accumulates the PSUM with a PSUM of a previous processing element module; and MEG is a 1-bit merge indicator, used to merge cross-column PSUMs;
the non-zero loader module feeds a non-zero weight into an array with corresponding (ID, CAS, MEG); and
when the input flows along the direction k, the processing element module performs multiplication according to ID of the weight; the processing element module selects any value from the local crossbar switch; after that, the PSUM is forwarded to a next processing element module along the direction j, where CAS indicates whether accumulation is performed; and whether to merge the PSUMs outputted from the bottom processing element module by MEG is checked.

4. The accelerator for accelerating the inference process of the unstructured sparse large language model according to claim 1, wherein the bitmask decoder module comprises a bitmask buffer module, a collection module, a decoder FIFO module, and a concatenation module;
the bitmask buffer module is connected to the collection module; the collection module is connected to the decoder FIFO module; and the decoder FIFO module is connected to the concatenation module; and
the collection module is responsible for reading an original bitmask from the bitmask buffer module, and through aggregation operations, concentrating scattered bit information into a lower-order part while setting a higher-order part to 0, and temporarily storing processed data in a decoder FIFO buffer, waiting for further processing; and the concatenation module is configured to decide when to read new data from FIFO on the basis of a weight validity signal, and concatenate the new data with existing data.

5. The accelerator for accelerating the inference process of the unstructured sparse large language model according to claim 4, wherein the bitmask decoder module translates the bitmask into an indicator to guide correct sparse computation on the diagonal dataflow systolic array; and
an input is a sparse bitmask from a first row to an N-th row; and the bitmask is then aggregated into a compact new row;
the collection module acquires an original bitmask from a bitmask buffer, after multiple rounds of continuous aggregation, all the bitmasks are finally concentrated in the lower-order part, with the higher-order part being 0, and the bitmasks are saved in the decoder FIFO buffer; and
the concatenation module acquires the new row from the FIFO according to the weight validity signal; if a length of the acquired data is insufficient for an output length of the new row, new data is read from the FIFO; after acquiring the data, it determines whether the data meets the length requirement of the new row; if the data does, the data is outputted, and remaining data is continuously and seamlessly concatenated and outputted in sequence.

6. The accelerator for accelerating the inference process of the unstructured sparse large language model according to claim 1, wherein the post-processing module comprises an activation function module, a SoftMax module, a residual addition module, a layer normalization module, a transpose module, and a rearrangement module;
the activation function module is configured to execute an activation function during the inference process of the large language model;
the SoftMax module is configured to map a value range of data of each node to [0, 1] and constrain a sum of output values of all output nodes to be 1;
the residual addition module is configured to add feature data from a previous step to feature data of a current step during the inference process;
the layer normalization module performs normalization operations on input data to constrain data values within a certain range;
the transpose module is configured to rotate a 32×32 matrix by swapping rows and columns and then save a transposed matrix to the DDR memory module; and
the rearrangement module is configured to rearrange skipped data into a sequential form and then save same as an entire block to the DDR memory module.

7. The accelerator for accelerating the inference process of the unstructured sparse large language model according to claim 1, wherein the KV cache module comprises an overflow module and a reload module;
the overflow module is configured to manage KV cache overflow and implement a last-in-first-out strategy; and
the reload module is configured to split an on-chip memory into a plurality of blocks, with each block storing a fixed number of token-based KV tensors.

8. The accelerator for accelerating the inference process of the unstructured sparse large language model according to claim 7, wherein the overflow module is configured to manage the KV cache overflow and implement the last-in-first-out strategy, comprising:
when the KV cache continues to grow and exceeds the capacity of the on-chip memory, transferring, by the overflow module, the KV tensors that exceed the capacity to the off-chip DDR memory module; and
during the cross-attention in a decoding stage, since frequent access to KV cache data is required, prioritizing keeping, by the overflow module, the KV tensors from early steps in the on-chip memory, and if space is insufficient, overflowing KV tensors from later steps.

9. The accelerator for accelerating the inference process of the unstructured sparse large language model according to claim 7, wherein the reload module is configured to split the on-chip memory into the plurality of blocks, with each block storing the fixed number of token-based KV tensors, comprising:
splitting the on-chip memory into N blocks, with each block storing M token-based KV tensors; pinning first M×(N−1) token-based KV tensors in first N31 1 memory blocks; and always remaining the first M×(N−1) token-based KV tensors on chip to reduce off-chip memory traffic; and
writing a newly generated KV tensor into a last memory block, and once M token-based KV tensors are accumulated in the block, overflowing the memory block to the off-chip memory;
where M is chosen to be equal to the size of the systolic array.

10. An operation method for an accelerator for accelerating an inference process of an unstructured sparse large language model, based on the accelerator for accelerating the inference process of the unstructured sparse large language model according to claim 1, comprising:
sending, by the computing core module, data requests to the interconnect bus module, and the interconnect bus module being communicated with the DDR memory module to transfer the required data to the computing core module;
converting, by the processor module, a large language model described in a high-level language into specific instructions and weight parameters, and storing the information in the DDR memory module via the direct memory access module;
starting the computing core module to read the instructions and the weight parameters from the DDR memory module, and performing arithmetic operations according to the instruction content; and exchanging, by different computing core modules, data via the router module to jointly complete complex non-linear function computation; and
processing, by the memory controller module, memory read and write requests from the interconnect bus module, and sending the requests to the DDR memory module to ensure that memory access requests from various modules are handled.
